(19) United States
(12) Patent Application Publication
(10) Pub. No.: US 2002/0185066 A1
(43) Pub. Date: Dec. 12, 2002

(54) Automobile tire detailing template

(75) Inventor: Vickee Lynn Newton, Kansas City, MO (US)

Correspondence Address: B. Trent Webb, SHOOK, HARDY & BACON L.L.P., 1200 Main Street, Kansas City, MO, 64105-2118, US

(73) Assignee: Other Things, Inc.

(21) Appl. No.: 09/876,800

(22) Filed: Jun. 7, 2001

(51) Int. Cl. B05D 1/32; B05C 11/11

(52) U.S. Cl. 118/504; 427/282

(57) ABSTRACT

The present invention provides an automobile tire detailing template comprising a circular shaped body which is complimentary in shape and size to the perimeter of a wheel of a automobile. In the preferred embodiment, the body of the present invention is a flat circle constructed of a plastomeric substance. The body includes two small holes positioned near the center of the body sized to receive a thumb and index finger of the user. The outer dimensions of the body are sized to conform to a conventional wheel of an automobile.

### CROSS REFERENCE TO RELATED APPLICATION

Not applicable.

### FIELD OF THE INVENTION

The present invention relates to automobile detailing and, more particularly, to a template for use in detailing an automobile tire.

### BACKGROUND OF THE INVENTION

Automobile owners take pride in the appearance of their vehicles. Many owners of automobiles spend a great deal of time and resources maintaining and improving the appearance of their vehicles. Automobile detailing, which is the activity of improving the aesthetic appearance of a vehicle, has become a significant industry in our economy.

Automobile detailing products span the spectrum of cleaning and polishing components. Many of these detailing products relate to vehicle finish, cleaning and polishing apparatuses. There also are many detailing products relating to the maintenance of the interior of the vehicle. In recent years, detailing components have been developed relating to the appearance of the vehicle's tires and wheels.

Many automobile owners consider the appearance of the tires and wheels of the vehicle to be very important. There are products on the market which can be applied to the tire of the vehicle to give it a shiny or wet appearance, which many consumers believe improves the appearance of the vehicle. Most of these tire treatment products are applied to the tire of the vehicle using a spray or aerosol application.

A significant problem has arisen relating to the application of these tire treatment components to the automobile tire. Chief among these problems is the overspray of the tire treatment product onto the actual wheel of the vehicle. Because the tire treatment product often is sprayed onto the tire, the consumer often is unable to control the application of the product and it also is inadvertently applied to the wheel of the vehicle. Many wheels of vehicles are chrome or otherwise reflective in appearance. If the tire treatment solution is applied to the wheel, the consumer finds it appearance to be unattractive. The tire treatment solution also can harm the finish of the wheel.

Before the present invention, the automobile owner was required to manually remove excess tire treatment solution from the wheel of the vehicle. This often required an additional step of wiping off the interior wheel of the vehicle after application of the tire treatment solution. This has proven to be a time consuming and messy exercise. Therefore, there is a need in this industry for a product which allows the application of a tire treatment solution to the tires of an automobile while preventing the tire treatment solution from coming into contact with the wheel of the vehicle.

### SUMMARY OF THE INVENTION

It is therefore an object of the present invention to provide a method and product for detailing an automobile tire which prevents the undesired application of a tire treatment solution onto the wheel of the vehicle.

More particularly, it is object of the present invention to provide a template which is placed over the wheel of the vehicle which conforms to the outer perimeter of the wheel to allow for the application of a tire treatment solution to the tire of the vehicle but not the wheel of the vehicle.

It is another object of the present invention to provide an automobile tire detailing method utilizing a template which can be placed over the wheel of the vehicle which allows for the application of a tire treatment solution to the tire of a vehicle.

It is yet another object of the present invention to provide a template which is capable of being varied in size to accommodate a number of different sizes of vehicle wheels.

It is also an object of the present invention to provide means for holding the template to the wheel of the vehicle which provides ease of use to the automobile owner.

It is still another object of the present invention to provide an automobile tire detailing template which includes a mechanism for removable attachment to the wheel of the vehicle. It is yet a further object of the present invention to provide an automobile tire detailing template which is simple and inexpensive to manufacture and which is adaptable to a number of different uses.

To accomplish these and other related objects, the present invention provides an automobile tire detailing template comprising a circular shaped body which is complimentary in shape and size to the perimeter of a wheel of a automobile. In the preferred embodiment, the body of the present invention is a flat circle constructed of a plastomeric substance. The body includes two small holes positioned near the center of the body sized to receive a thumb and index finger of the user. The outer dimensions of the body are sized to conform to a conventional wheel of an automobile. In operation, the user grasps the body by inserting their thumb and index finger into the positioning holes. The user then places the template against the wheel of the vehicle. While holding the template against the wheel, the user applies the tire treatment substance to the circumferentially exposed tire. After the application of the solution is terminated, the user removes the template from the wheel.

### BRIEF DESCRIPTION OF THE DRAWINGS

The accompanying drawing form part of the specification. The drawings are to be read in conjunction with the specification. Reference numerals have been used to indicate like parts in the various views of the drawings.

FIG. 1 is a perspective view of the template of the present invention showing the template being held by a user and being aligned for positioning against the wheel of an automobile vehicle;

FIG. 2 is a perspective view of the template of the present invention showing the template being pressed against the wheel of the vehicle while a tire treatment solution is being applied to the circumferentially exposed tire;

FIG. 3 is a fragmentary perspective view of an alternative embodiment of the present invention having parts being broken away to show details of construction wherein the template is slightly domed in cross-section to accommodate certain vehicle wheels; and

FIG. 4 is a fragmentary side elevational view ofyet another embodiment of the present invention, parts being broken away to illustrate details of construction, spaced laterally from the wheel and tire of an automobile and showing the wheel of the vehicle projecting laterally outwardly from the tire of the vehicle, and also showing, in phantom lines, the alternative embodiment of the template being applied to the wheel of the vehicle and being spaced outwardly therefrom.

### DESCRIPTION OF THE PREFERRED EMBODIMENT

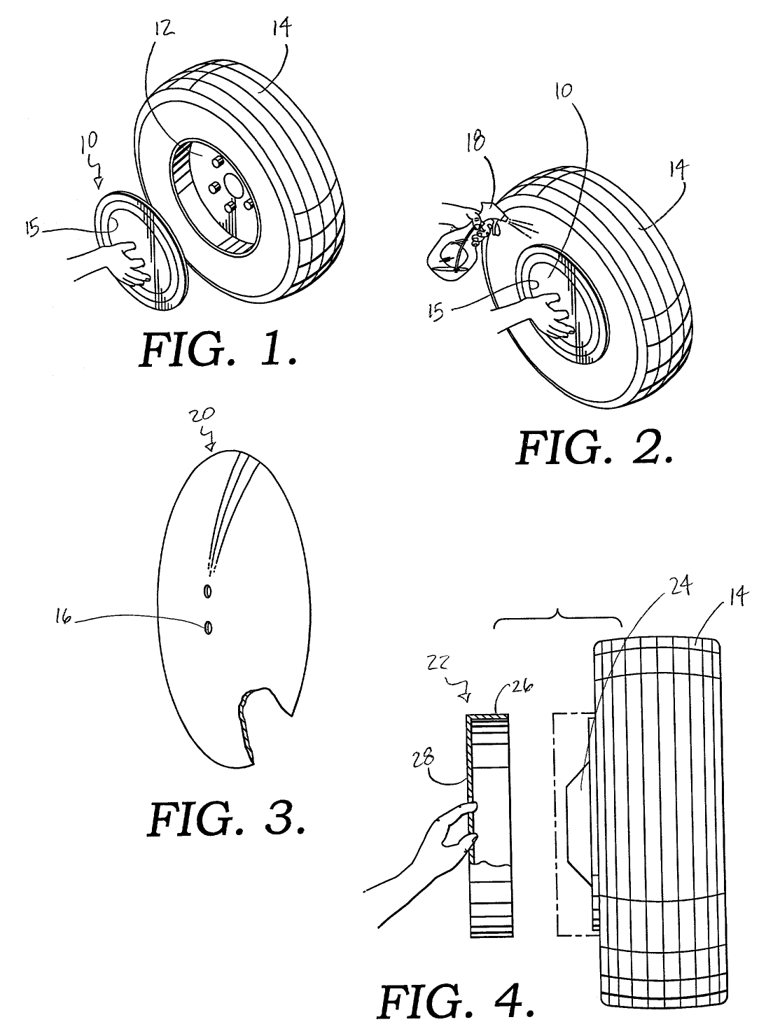

Referring now to the drawings in greater detail, and initially to FIG. 1, an automobile detailing template constructed in accordance with the present invention is broadly designated by the numeral 10. Template 10 is shown being aligned with the wheel 12 of a vehicle. A tire 14 is mounted on the wheel 12.

Template 10 is generally circular in shape to conform to the generally circular wheels of an automobile. Template 10 may be constructed of any suitable material, but is preferably constructed of a plastomeric substance. The plastomeric substance is preferred because of its reduced solution absorbing characteristics. If surplus tire treatment solution is applied to the template 10, it can easily be wiped away without excessive absorption. This allows for the reuse of the template 10. If reuse of the template 10 is not desired, the template 10 can be constructed of virtually any material, including cardboard or stock paper. Any composition of construction which can be utilized to make the template 10 is within the scope of the present invention.

The thickness of the template 10 varies depending on the desired application. It is to be understood that in order to make the template 10 more robust and rigid, a thicker material may be employed. Otherwise, the template 10 can be constructed of any material that is suitably thick or rigid to provide the template 10 with the desired stability to be placed against the wheel 12 of the vehicle without buckling or sagging of the template 10.

The diameter of the template 10 varies depending upon the size of the wheel 12 with which the template 10 is to be used. For example, if the automobile has 17″ wheels, a 17″ template 10 should be used. Alternatively, if the automobile has 15″ wheels, a 15″ template 10 should be used. It is important that the template 10 of the present invention conform substantially to the outer perimeter of the wheel 12 of the vehicle. This allows for the application of a tire treatment solution to the tire 14 of the vehicle without the solution also being applied inadvertently to the wheel 12. Generally, the outer periphery of the template 10 will conform with and extend slightly beyond the outer perimeter of the wheel 12. This prevents the undesired exposure of the wheel 12.

In the preferred embodiment of the present invention, the template 10 is slightly larger than 19″ in diameter. In this embodiment, the template 10 includes concentric circle indicia 15 on the outer surface of the template 10. These concentric indicia 15 form circles of varying diameters. For example, a 19″ version of template 10 may display concentric indicia forming diameters of 18″, 17″, 16″, and 15″. This allows for a template 10 to be used on a number of different sizes of vehicle wheels, from at least 12″ to 22″ in diameter.

For example, a user may purchase a 19″ template 10 even though the purchaser owns a vehicle having 16″ wheels. In use, the purchaser of the template 10 will cut or otherwise remove the portions of the template 10 lying outside the 16″ concentric indicia. The result will be a 16″ template 10 which can be used by the purchaser on his or her vehicle.

In the preferred embodiment, the concentric indicia are merely applied to the outer surface of the template 10. This may be done with ink, paint or other related means. The consumer may then cut with scissors or other implements that portion of the template 10 not needed for use. It is to be understood that other indicia may be used, such as perforations or other lines of weakness, which would allow the unwanted portions of the template 10 to be removed by bending or breaking the material away.

In the preferred embodiment, the template 10 includes positioning holes 16. Positioning holes 16 are located near the center of the template 10 and are sized to receive the thumb and index finger of the user. In operation, the user inserts his or her thumb and index finger into the holes thereby allowing the user to manipulate the template 10 quite easily. It is to be understood that other numbers of holes may be employed with the present invention without departing from its scope. In addition, it is understood that handles or other external structures may be applied to the template 10 to provide a more secure handling mechanism for the invention. These mechanisms also are within the scope of the present invention.

FIGS. 1 and 2 show the present invention being used. As seen in FIG. 1, the user first grasps the template lousing positioning hole 16. In FIG. 2, the template 10 is shown being applied to the wheel 12 of the vehicle. It should be noted that the template 10 extends slightly beyond the outer periphery of the wheel 12. Once the template 10 is positioned properly, a tire treatment solution 18 is applied to the tire 14 of the vehicle by spraying the solution directly onto the tire 14. Template 10 covers the wheel 12 of the vehicle. This prevents the undesired application of the tire treatment solution 18 onto the wheel 12 of the vehicle. The application of the tire treatment solution is then terminated. The template 10 is removed from the wheel 12.

FIG. 3 shows an alternative embodiment of the present invention designed by the numeral 20. The template 20 shown in FIG. 3 is slightly domed in shape. This allows for the ease of use of the template 20 on certain wheels which have a lateral profile extending beyond the tire 14 of the vehicle. The template 20 is domed only slightly to permit a small lateral profile of the wheel 12. The dome configuration of template 20 provides many of the same benefits of low cost and ease of manufacturing as the preferred embodiment of template 10.

FIG. 4 shows yet another embodiment of the present invention. The alternative embodiment shown in FIG. 4 is designated by the numeral 22. Template 22 is designed for use with wheels which have a significant lateral profile extending beyond the tire 14 of the vehicle. A wheel having such a profile is designated in FIG. 4 by the numeral 24. Template 22 includes an annular lip or flange 26 extending outwardly from a generally flat body 28. In use, the template 22 is applied against the wheel 24 of the vehicle. Template 22 is spaced outwardly from the wheel 24 by annular lip 26. The phantom lines shown in FIG. 4 illustrate template 22 as it is applied against wheel 24. The template 22 is spaced outwardly from the wheel 24 to allow a substantially conforming fit of the template 22 to the wheel 24 while also accommodating the lateral profile of the wheel 24.

In the preferred embodiment, there are no external means associated with template 10 to secure it to the wheel 12 of the vehicle. However, in some instances it may be advantageous to use certain external means to secure the template 10 to the wheel 12 of the vehicle to allow hands-free operation. Such securing means may include magnetic strips disposed around the periphery of the template 10 which secure the template 10 to the metal wheel 12 of the vehicle. An adhesive may also be used to secure the template 10 to the wheel 12. These and other related mechanisms are within the scope of the present invention.

In addition, in yet another alternative embodiment, template 10 may also include a sealing mechanism around the periphery of the template 10. This sealing mechanism may include a rubber gasket or other flexible and liquid tight structure for preventing undesired application of a tire treatment solution to the wheel 12 of the vehicle. These sealing mechanisms are well known to those of ordinary skill in the art and are within the scope of the present invention.

The present invention provides a simple and inexpensive solution to the problem of undesired application of the tire treatment solution to the wheel of a vehicle. The template of the present invention is extremely easy to manufacture and, in some instances, may be merely punched out of flat pieces of plastic. The cost associated with the manufacture of the template are minimal. In addition, the template may be easily used by the consumer without significantly adding to the complexity or time associated with the process of applying a tire treatment solution to the tire of a vehicle. In fact, the template of the present invention reduces the time associated with detailing the tires of the vehicles by eliminating the additional and unnecessary step of removing undesired tire treatment solution from the wheel of the vehicle. The template of the present invention also is adaptable to a number of different sizes of wheels. In the preferred embodiment having concentric indicia on the surface of the template, a consumer need only purchase a single size of template for virtually any size of wheel. This will be a significant advantage to both the casual automobile detailer as well as the professional automobile detailer.

From the foregoing, it is clear that this invention is well adapted to attain all the objects set forth above together with all other advantages which are inherent to the invention. It is to be understood that certain features and subcombinations are of utility and may be employed without reference to other features and subcombinations. Because many possible embodiments may be made of the present invention without departing from its scope, it is to be understood that all matters set forth herein are shown in the drawing is to be interpreted as illustrative and not in a limiting sense.

What is claimed is:

1. An automobile tire detailing template comprising:
a circular-shaped body generally conforming to the shape of a vehicle wheel; and
means for holding the body, whereby the template may be placed against a wheel of a vehicle to prevent the undesired application of a tire treatment solution to the wheel.

2. The template of claim 1 wherein the means for holding the body includes at least one hole positioned near the center of the body.

3. The template of claim 2 wherein the means for holding the body includes two holes positioned near the center of the body.

4. The template of claim 3 wherein the body is constructed of a plastomeric material.

5. The template of claim 4 further comprising concentric indicia disposed on at least one surface of the body.

6. The template of claim 5 further comprising means associated with the body for releasably securing the body to the wheel of a vehicle.

7. The template of claim 6 wherein the means for releasably securing the body includes at least one magnet mounted near the perimeter of the body.

8. The template of claim 1 wherein the body is domed.

9. A method of detailing an automobile tire comprising:
providing an automobile tire detailing template;
placing the template against a wheel of a vehicle;
applying a tire treatment solution to a tire of the vehicle; and
removing the template from the wheel;
whereby the undesired application of the tire treatment solution to the wheel is avoided.

10. The method of claim 9 further comprising the step of manually maintaining the template against the wheel during the step of applying tire treatment solution.
